(19) United States
(12) Patent Application Publication
(10) Pub. No.: US 2003/0145255 A1
(43) Pub. Date: Jul. 31, 2003

(54) Hierarchical multi-component trace facility using multiple buffers per component

(76) Inventors: Anthony Walter Harty, Superior, CO (US); Brian Dennis McKean, Longmont, CO (US); Theresa L. Segura, Broomfield, CO (US)

Correspondence Address: ARTHUR J. SAMODOVITZ, IBM CORPORATION, N50/040-4, 1701 NORTH STREET, ENDICOTT, NY, 13760, US

(21) Appl. No.: 10/047,223

(22) Filed: Jan. 15, 2002

(51) Int. Cl. H02H 3/05

(52) U.S. Cl. 714/48; 714/38; 714/39

(57) ABSTRACT

Disclosed is a system and a method for implementing trace buffers in a computer program. A trace facility monitors operation of the computer program in real time. As the code is executed, error-related events occur and are divided into at least three components, including errors, warnings, and messages. Records of these events are stored in the trace buffers. Each task, process, or component of the embedded system that is traced may have an independent set of trace buffers. Unique events eliminate the confusion as to where or when an event occurs in a system. Separate trace buffers for each component of the embedded system ensure that no component consumes buffer resources needed by other components. The trace facility may be embedded in the code in a transparent manner and may be utilized to locate errors on-site.

### BACKGROUND OF THE INVENTION

1. The Field of the Invention

The invention relates to embedded systems used to locate and document program errors. More specifically, the present invention is related to systems and methods for implementing multiple trace buffers to identify errors within a program.

2. The Relevant Art

Knowledge of the internal operation of code and micro-code within a computer is useful for debugging, optimization, and design verification. Viewing the internal operation of programs, known as tracing, provides a view into the behavior of the programs by recording the time and details of the state of the programs at relevant points in the operation of the programs.

Tracing is a broadcast form of inter-process communication with many source processes (e.g., writer entities) and sink processes (e.g., reader entities) capable of observing each other's execution. A trace, therefore, consists of embedded code that chronicles the actions and results of program execution. Specifically, the trace provides a detailed record of the program's execution path by, for instance, placing an application program under observation by a dedicated routine that monitors the progress of the program.

Performance information obtained by writer entities engaged in tracing operations is typically provided to the registry in the form of trace scripts. Each trace script has a variable length and is stored in a portion of the registry configured to accommodate such variable-length messages. This storage location is generally known as a trace buffer.

A plurality of messages and corresponding fragments are generally interleaved within the trace buffer, which is typically shared among the software components or other entities being monitored. The trace buffer may be accessed by multiple writer entities attempting to load messages into the buffer and multiple reader entities attempting to retrieve those messages.

Traces provide computer engineers with a view of process and data states while the computer systems are operating in real-time. Hardware engineers often use traces to determine how new computer hardware architectures will perform with many different types of operating systems and application programs. Specific designs of hardware structures, such as instruction processors and data memories, can have drastically different and sometimes unpredictable utilizations for the same sets of instructions and data. It is important that any flaws in the hardware design are found before the design is finalized.

Software engineers are also often required to identify critical information about code segments and data structures. For example, it is useful for compiler writers to know how the compiler schedules instructions for execution and how well conditional branches are predicted to provide input for code optimization. It is similarly useful for software engineers debugging programs to investigate the exact execution and data flow in an errant code segment.

One manner of providing a trace system to locate errors in a coded program involves embedding the trace system within the program it is to debug. An embedded trace system allows the system to evaluate each section of the code while the computer system is running various programs. By embedding the system, the user is not required to start the debugging process, provide commands or prompts, or wait while the tracing system scans the program.

An embedded tracing system also decreases the possibility of erroneous changes being made to the tracing system. Typically in an embedded trace system, users are unable to access the code of the tracing system, change the code, and render the tracing system unmanageable. This provides for a certain level of security to the code containing the tracing system.

As it is known in the art, computer systems generally include a central processing unit, a memory subsystem, and a storage subsystem. According to a networked or enterprise model of a computer system, the storage subsystem associated with or in addition to a local computer system may include a large number of independent storage devices or disks housed in a single enclosure. This array of storage devices is typically connected to several computers (or hosts) via dedicated cabling or via a network. Such a model allows for the centralization of data that is to be shared among multiple users and allows a single point of maintenance for the storage functions associated with various computer systems.

One such system is generally referred to as RAID (Redundant Array of Independent Disks) systems. A RAID system is one example of an environment where an embedded trace system might be implemented to debug the program code. A RAID system is described as an arrayed configuration of inexpensive hard disks, configured to provide fault tolerance (redundancy) and improved access rates. RAID systems provide a method of accessing multiple individual disks as if the array were one larger disk, spreading data access out over these multiple disks, and thereby improving access time and reducing the risk of losing all data if one drive fails.

In a multitasking embedded environment such as the RAID system, the ability to trace sufficient and pertinent symptoms is necessary for expedient debugging. This need is relevant throughout the entire development process, but becomes more so as a product reaches maturity.

Prior art methods of tracing generally utilize a single buffer to store trace information. Selections of events to include in this single buffer have proven to be problematic. For instance, RAM memory is often used to store the records of the tracing. The size and amount of RAM memory is typically limited, due to the costliness of RAM in computer systems, and consequently the storage capacity that can be assigned to the trace buffer is similarly limited.

As the tracing commences within prior art systems, both messages and events are stored in the common buffer. Due to the size constraint, the buffer frequently becomes full and incapable of storing additional information. Previous messages and events that had been stored are either discarded or overwritten to provide room for new messages and events within the buffer. The user is thus unaware of the earlier events, which might be pertinent and even critical to the debugging or other operation on the system being traced.

From the above discussion, it can be seen that it would be a beneficial addition in the art to provide an improved tracing technique. Particularly, it would be advantageous to provide an improved trace buffer that is more flexible and less subject to information overruns.

### OBJECTS AND BRIEF SUMMARY OF THE INVENTION

The tracing facility of the present invention has been developed in response to the present state of the art, and in particular, in response to the problems and needs in the art that have not yet been fully solved by currently available tracing facilities. Accordingly, it is an overall object of the present invention to provide a tracing facility that overcomes many or all of the above-discussed shortcomings in the art.

The tracing facility of the present invention is highly suitable for locating errors in an embedded system. The embedded system in one embodiment comprises a segment of program code, a plurality of buffers, and a tracing module configured to locate events within the segment of program code which are useful for finding and correcting errors. The tracing module is also configured to selectively transmit the events to the plurality of buffers.

Each buffer in the plurality of buffers may be configured to store a different type of event from the other buffers. The different types of events stored within the plurality of buffers may comprise, by way of example, errors, warnings, and messages. The plurality of buffers may be assigned to a single segment of program code or may be distributed among a plurality of functional components of a computer program, with each buffer or set of buffers assigned to a different functional component of the program code.

A merging module within or external to the embedded system of the tracing facility is preferably configured to combine the events from the plurality of buffers into a common list of events. The list of events may be organized in a chronological order according to a timestamp placed on each event stored in a buffer. The merging module is preferably also configured to selectively combine the events. Accordingly, each event stored in the plurality of buffers may be stored together with information about the event such as the type of event, the location of the program code where the event took place, and the time of the event.

A method of the present invention for providing an embedded system with a trace facility is also provided. The method comprises providing a plurality of buffers configured to store events useful in finding and correcting errors, tracing the events within a segment of program code, and selectively storing the events within the plurality of buffers. The events are preferably stored according to the types of the events, including errors, warnings, and messages.

The method also preferably comprises distributing the plurality of buffers among a plurality of functional components of the program code, with each buffer assigned to a different functional component. The events may then be merged from the plurality of buffers into a common list of events, organized chronologically. A timestamp is preferably placed on each event stored in the plurality of buffers to facilitate chronological organization.

These and other objects, features, and advantages of the present invention will become more fully apparent from the following description and appended claims, or may be learned by the practice of the invention as set forth hereinafter.

### BRIEF DESCRIPTION OF THE DRAWINGS

In order that the manner in which the advantages and objects of the invention are obtained will be readily understood, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 is a block diagram of a computer system suitable for implementing the present invention;

FIG. 2 is a schematic block diagram illustrating one embodiment of a trace facility of the present invention;

FIG. 3 is a schematic flow chart diagram illustrating one embodiment of a process of the present invention for developing a software product using a tracing program code;

FIG. 4 is a schematic flow chart diagram illustrating one embodiment of a method for tracing program code within a computer system; and

FIG. 5 is a schematic flow chart diagram illustrating one embodiment of a method for merging events stored in separate buffers in accordance with the present invention.

### DETAILED DESCRIPTION OF THE PREFERRED EMBODIMENTS

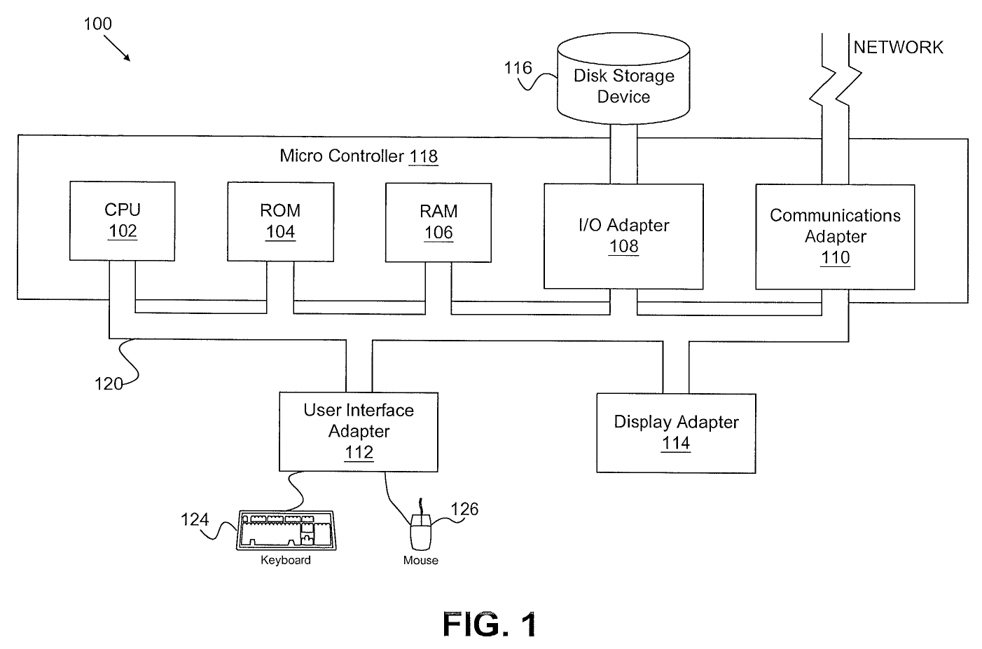

FIG. 1 schematically illustrates one example of a computer system 100 suitable for implementing the present invention. A central processing unit (CPU) 102 is provided and is interconnected to the various other components by a system bus 120. The hardware trace facility of the present invention may be adapted to operate within the CPU 102. A read only memory (ROM) 104 is connected to the CPU 102 via the system bus 120 and includes the basic input/output system (BIOS) that controls the basic computer functions. A random access memory (RAM) 106, an I/O adapter 108, and a communications adapter 110 are also interconnected to the system bus 120. The I/O adapter 108 may be a small computer system interface (SCSI) adapter that communicates with a disk storage device 116. The communications adapter 110 interconnects via the system bus 120 with an outside network enabling the data processing system to communicate with other such systems.

The CPU 102, ROM 104, RAM 106, I/O adapter 108, and communications adapter 110 may be provided in the form of a micro-controller 118 having a microprocessor and integrated peripherals on the same chip. The disk storage device may comprise a plurality of hard disk drives configured in a RAID array. The peripherals may include RAM and ROM memory, interrupt structures, communication means, timing and data acquisition circuits.

Representative Input/Output devices are also shown connected to the system bus 120 via a user interface adapter 112 and a display adapter 114. A keyboard 124 and mouse 126 are all shown interconnected to the system bus 120 via the user interface adapter 112. In this manner, a user is capable of inputting to the system through the keyboard 124 or mouse 126 and receiving output from the system via output components such as the display adapter 114.

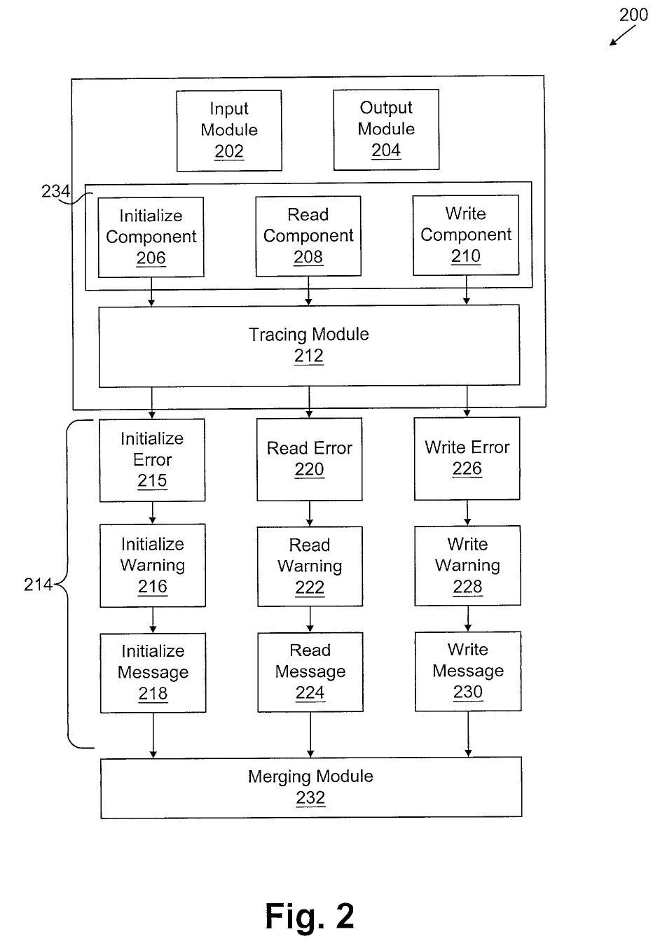

FIG. 2 is a schematic block diagram illustrating one embodiment of a trace facility 200 of the present invention. The trace facility 200 is preferably implemented as computer readable code and may be stored in memory 104, 106, 116 and implemented within a CPU such as the CPU 102 of FIG. 1. In one embodiment, the trace facility is implemented as micro-code within a micro-controller 118.

In the depicted embodiment, the trace facility 200 is implemented to chronicle or document errors in the program 234 and may be embedded within the program 234. Within the trace facility 200, an input module 202 is configured to receive input information from the user to the system. A keyboard 124 or mouse 126 of FIG. 1 may comprise suitable devices for communicating with the input module 202. An output module 204 is configured to output information from the system to the user. Components interconnected to a display adapter 114 such as a computer monitor or a printer may be used to communicate with the output module 204.

The program 234 may comprise any type of computer program within which it is desirable to locate errors as they occur in real time. In one embodiment, the program 234 is broken into logical components. Shown by way of example for illustration purposes only are components including an initialize component 206, a read component 208, and a write component 210. Each component of the program 234 may be configured to have its code traced by a tracing module 212. The tracing module 212 is thus configured to record events from the operation of selected segments of code from the individual components that together comprise the system program code. Records of these events, which in the prior art are stored in a single trace buffer, are stored in a plurality of trace buffers under the present invention.

In one embodiment, the tracing module 212 is a function that is called with parameters indicating the event that has occurred. The tracing module 212 is preferably placed throughout the program code being traced on an as-needed basis. The tracing module 212 thus is a valuable tool that records events for later analysis to facilitate the location of errors.

In the depicted embodiment, nine trace buffers 214 are depicted. Nevertheless, any suitable number of trace buffers may be used. Also in the depicted embodiment, the trace buffers 214 are categorized in different manners. For instance, the plurality of trace buffers 214 may be organized by the type of event stored. In the depicted embodiment, three types of event buffers—errors, warnings, and messages—are shown. By separating the buffers into types, certain problems are alleviated. For instance, there may be a hierarchy among the types, so more important events such as errors get preferential treatment. Also, using this scheme, sufficient space can be allocated to the more important events so that, for instance large amounts of warnings do not cause errors to overflow.

Another manner of categorizing the plurality of buffers is by functional components of the program 234. For instance, the depicted program 234 is shown by way of example to be divided conceptually (although the code may also be physically divided such as by procedures, objects, or data structures) into three components, the initialize components 206, the read component 208, and the write component 210. Three buffers are shown allocated to each component.

Accordingly, during operation, when the tracing module 212 records errors in the code of the initialize component 206, the errors are stored as initialize component errors 214. Events occurring within the initialize component 206 that are traced by the tracing module 212 and are evaluated as warnings are stored as an initialize warning 216, and events traced as messages are stored as an initialize message 218. Events located by the tracing module 212 as occurring within the read component 208 and write component 210 are handled in a similar manner according to the assigned buffers.

After the code for each of the individual components of the system program code 234 has been traced and evaluated by the tracing module 212, and a user is ready to view the results, a merging module 232 may be used to combine the stored codes from the disparate buffers 214. The merging module 232 may, for instance, be configured to organize all the error events, including, the errors found in the initialize component 206, the errors found in the read component 208, and the write component 210 into a single list. Similarly, all warnings may be combined, and all messages may be combined. Furthermore, all events for a component may be combined, and all events for the program 234 may be combined. The events may be combined in any suitable combination. This allows the user, or system administrator to identify errors, warnings, and messages found in each component in a short amount of time. Preferably, each event is time stamped when placed in the buffers 214 so that when the events are combined they may be listed in chronological order.

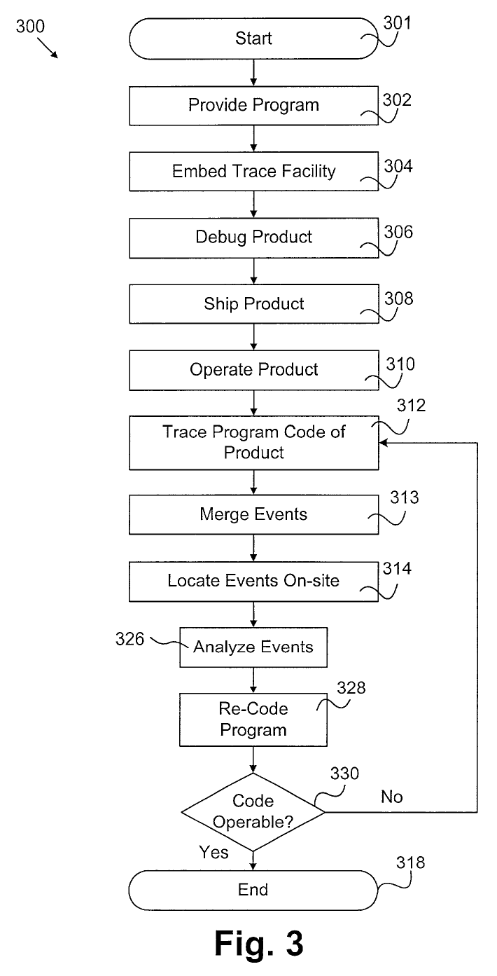

FIG. 3 is a schematic flow chart diagram illustrating one embodiment of a process 300 for developing a software product using a tracing facility of the present invention. While the method 300 may be conducted independently of the system of FIGS. 1 and 2, the method 300 will be described herein by way of example with reference to the systems 100 and 200 of FIGS. 1 and 2. The process starts 301, and a program is provided 302. A trace facility 200 is then provided 304, and in one embodiment is embedded 302 in the program 234.

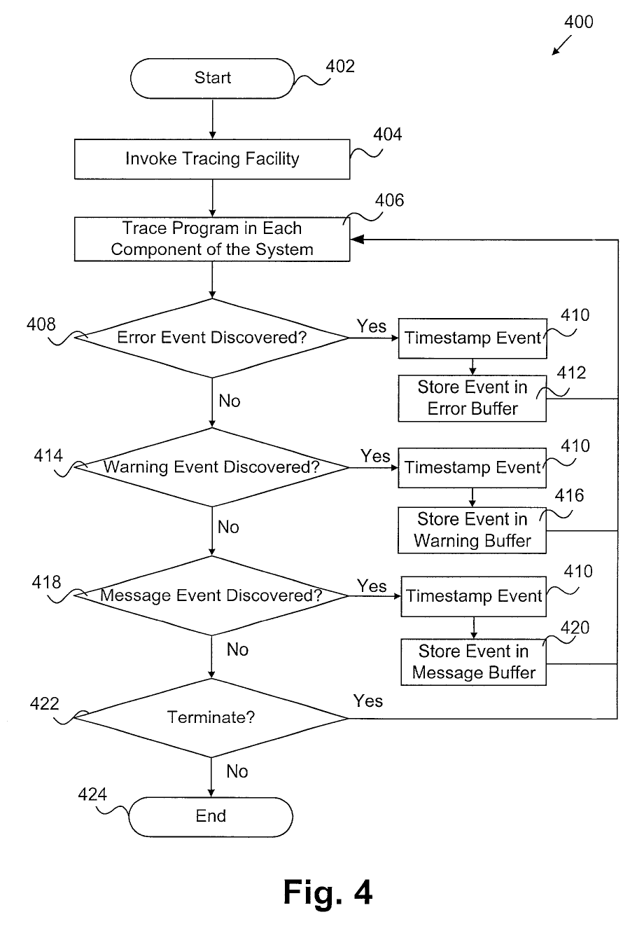

During development of the software, the developers perform tests on the software to thoroughly find and correct any errors (bugs) located within the software. This step is commonly known as debugging 306 the product. The tracing facility may be used at this step in a manner that is described in greater detail with reference to FIG. 4. Once the product has been thoroughly tested and debugged, the product is shipped 308. The product is then received and begins operation 310. In one embodiment, the tracing facility is embedded within the program 234 and may be transparent to the user.

The developer or the user may use the trace facility to trace 312 and continue debugging the product at any time during the life of the product on-site and in real time. In so doing, events discovered within the program 234 are optionally merged into a single buffer 313. Thus, in one embodiment, using the trace facility errors, warnings, and messages are detected within the product on-site 314 and in real time. This allows the program code to be easily tested and debugged even after the product has been shipped and installed. Located errors, warnings, and messages are then analyzed 326.

Errors and issues arising from warnings may then be corrected in one embodiment by recoding 328 the program. Once the program has been recoded, tests are conducted to determine whether the program is operable 330 or otherwise suited to its purpose. If so, the method 300 ends 318. If more testing is needed, either because the program is visibly unsatisfactory or because errors, warnings, and/or messages are still present, the method 300 again returns to trace 312 the program code and locate events in search of a solution to the indicated errors and issues.

FIG. 4 is a flow chart diagram illustrating one embodiment of a method 400 for tracing a segment of program code in accordance with the present invention. The method 400 may be employed in one embodiment as the “Trace Program Code” step 312 of FIG. 3.

The method 400 begins 402, and the tracing facility is invoked 404. The tracing facility is then used to trace 406 the program code of each component 206, 208, 210 within the program 234. As the program code in a component is traced, events occur 408. Each traced event is noted and is preferably time stamped 410. Time stamping events 410 permits post-processing of the buffers, in such a way that events from all buffers or selected buffers may be merged chronologically in a manner to be discussed. When an event is identified as an error, a record of the event is made and then is time stamped 410 and stored 412 in an error buffer. The method 400 then returns to step 404 and continues checking for more events.

Referring now to step 414, a recognized event may be identified as a warning. A warning generally comprises code that may potentially become an error and render the program code of the system inoperable or unsuited for its intended purpose. Following the discovery of a warning event 414, a copy of the event is time stamped 410 and stored 416 in a separate buffer configured to store warning events of the particular component being traced.

Referring to step 418 an event may also be recognized as a message event. Messages allow the user or system administrator to review past history of the traces and to verify the function of the individual components program code. A copy of the message event is time stamped 410 and then stored in a separate buffer 420 configured to store message events of the particular component. Three types of events are illustrated in FIG. 3. Nevertheless, it should be readily apparent that events may be tracked that differ from those shown.

After the event is stored in buffers 416, 418, or 420, the method 400 continues tracing the program code until a terminate command is received 422. The terminate command may be generated by a user or as a consequence of the termination of the program being traced. When a terminate command is received 422, the method 400 ends.

Table 1 is one example of the possible contents of event buffers 214 in which events are recorded in accordance with the methods 300, 400.

TABLE 1
Component 1 Trace

| | | | | | | | |
|---|---|---|---|---|---|---|---|
| Time | Function | State1 | State2 | Vars1 | Vars2 | Event | Free1 |

Errors

| | | | | | | | |
|---|---|---|---|---|---|---|---|
| 25684779 | FunctionName1 | 0000 | 0000 | 0005 | 0151 | 00AC | 0000 |
| 25784300 | FunctionName2 | 9B24 | 0000 | 0001 | 0005 | 013F | 0000 |

Warnings

| | | | | | | | |
|---|---|---|---|---|---|---|---|
| 25784901 | FunctionName2 | 9B23 | 0000 | 0005 | 0151 | 013A | 0000 |
| 25790200 | FunctionName3 | 9B24 | 0000 | 0001 | 0005 | 0122 | 0000 |
| 25790999 | FunctionName3 | 9B24 | 0000 | 0001 | 0005 | 0122 | 0000 |

Messages

| | | | | | | | |
|---|---|---|---|---|---|---|---|
| 21684712 | FunctionName4 | 9B24 | 0000 | 0005 | 0151 | 010F | 0000 |
| 22734407 | FunctionName2 | 9B24 | 0000 | 0001 | 0005 | 01F5 | 0000 |
| 23334000 | FunctionName1 | 9B24 | 0000 | 0000 | 000F | 01F3 | 0000 |
| 23785393 | FunctionName2 | 9B24 | 0000 | 0001 | 0005 | 01F5 | 0000 |

Table 1 contains several columns with headings and data or names below each heading. The first column labeled time, indicates the time stamp of the event. The time stamp allows the user to know when the event was recorded by the tracing facility. The measurement of the timestamp is shown in the depicted embodiment as clock cycles of the CPU.

Program code is typically organized with different functions. The second column labeled function, indicates the function name within the code where an event was discovered.

The third and fourth columns labeled State1 and State2, are examples of a certain state that a functional area or component might be in at that point in time. The state is usually a global variable which implies that the function might be left for a certain amount of time, and upon returning to that function the state it was in is stored within the code. An example of State1 might be a read state, and an example of State2 might be a write state. The code listed below State1 and State2 is a pre-defined position of that state. For example, the code “0000” below State1 in table 1 under Errors, might indicate a read-ahead state, while “9B24” might indicate a read-backwards state.

The next columns in table 1 labeled Vars1 and Vars2, indicate the effected variable or object within the function where an event was discovered. The values listed below Vars1 and Vars2 are examples of actual values of the variable or object. The value “0005” listed in Table 1 under Errors and Vars1 may indicate the value of Vars1 at that point in time. The user is then able to determine the cause of the error, warning, or message. For example, the value may be too large or too small for the parameters of that particular function within the code being traced. Each function has several variables that may be listed and their values recorded.

The next column labeled Event, indicates a pre-programmed event that needs to be identified. In accordance to the present invention, the events might be identified as errors, warnings, and messages. The values listed below event indicate the type of error, warning, or message that occurred within the functional area or component being traced.

The last column allows for robustness within the present invention. The user is able to add other variables, functions, etc. that are desired to be traced. For example, as the maturity of a product increases, it may become necessary to record more information. Additional variables may be added under the free1 column to allow for this added storing of information. Of course, the errors, messages, and warnings may be stored within separate buffers.

Table 2 is an example of a buffer storing the tracing of a second component of the computer program where the results of tracing the components are stored (e.g., 412, 416, and 420) in separate post-processing buffers (e.g., buffers 214 of FIG. 2).

TABLE 2
Component 2 Trace

| | | | | | | | |
|---|---|---|---|---|---|---|---|
| Time | Function | State1 | State2 | Vars1 | Vars2 | Event | Free1 |

Errors

| | | | | | | | |
|---|---|---|---|---|---|---|---|
| 25553010 | FunctionName39 | 9B20 | 0000 | 00FD | 0005 | 2046 | 0000 |

Warnings

| | | | | | | | |
|---|---|---|---|---|---|---|---|
| 25341009 | FunctionName48 | 9B20 | 0000 | 000F | 0151 | 204B | FAA8 |
| 25784420 | FunctionName46 | 9B20 | 0000 | 000A | 0005 | 204C | 5BCD |

Messages

| | | | | | | | |
|---|---|---|---|---|---|---|---|
| 28600716 | FunctionName48 | 9B20 | 0000 | 000F | 0151 | 2001 | FAA8 |
| 29124801 | FunctionName50 | 9B20 | 0000 | 000D | 0005 | 2002 | 0000 |
| 29984775 | FunctionName50 | 9B20 | 0000 | 000D | 0005 | 2010 | 0FFF |

The definition and description of the columns listed in table 2 are the same as those listed above describing table 1. Similar buffers may likewise be used and filled for each component of a program in this manner.

Once the tracing facility has traced (406) the program code of each component comprising the system, an analysis of the discovery of any types of events occurs. Should there be no events stored in the buffers, the system continues to operate normally. However, if events have been identified, time stamped, and stored in buffers, a merging of events (e.g., step 313) may occur. A request to merge may be initiated by an authorized user through an interface. All events are preferably time stamped (410) with equal granularity and from the same clock. The timestamps may then be used to merge multiple buffers during post processing, enabling a visual representation of when events actually occurred to be analyzed.

Table 3 is one example of the post-processed buffers from Component 1 and Component 2 merged according to the time stamp of each event stored.

TABLE 3
Component 1 and Component 2 Merged Trace

| Time | Function | State1 | State2 | Vars1 | Vars2 | Event | Free1 | EWM | Comp. |
|---|---|---|---|---|---|---|---|---|---|
| 21684712 | FunctionName4 | 9B24 | 0000 | 0005 | 0151 | 010F | 0000 | Message | 1 |
| 22734407 | FunctionName2 | 9B24 | 0000 | 0001 | 0005 | 01F5 | 0000 | Message | 1 |
| 23334000 | FunctionName1 | 9B24 | 0000 | 0000 | 000F | 01F3 | 0000 | Message | 1 |
| 23785393 | FunctionName2 | 9B24 | 0000 | 0001 | 0005 | 01F5 | 0000 | Message | 1 |
| 25341009 | FunctionName48 | 9B20 | 0000 | 000F | 0151 | 204B | FACC | Warning | 2 |
| 25553010 | FunctionName39 | 9B20 | 0000 | 00FD | 0005 | 2046 | 0000 | Error | 2 |
| 25684779 | FunctionName1 | 0000 | 0000 | 0005 | 0151 | 00AC | 0000 | Error | 1 |
| 25784300 | FunctionName2 | 9B24 | 0000 | 0001 | 0005 | 013F | 0000 | Error | 1 |
| 25784420 | FunctionName46 | 9B20 | 0000 | 000A | 0005 | 204C | 5BCD | Warning | 2 |
| 25784901 | FunctionName2 | 9B23 | 0000 | 0005 | 0151 | 013A | 0000 | Warning | 1 |
| 25790200 | FunctionName3 | 9B24 | 0000 | 0001 | 0005 | 0122 | 0000 | Warning | 1 |
| 25790999 | FunctionName3 | 9B24 | 0000 | 0001 | 0005 | 0122 | 0000 | Warning | 1 |
| 29124801 | FunctionName50 | 9B20 | 0000 | 000D | 0005 | 2002 | 0000 | Message | 2 |
| 29984775 | FunctionName50 | 9B20 | 0000 | 000D | 0005 | 2010 | 0FFF | Message | 2 |

The descriptions and definitions of the columns in table 3 are again the same as the definitions used to described the columns in table 1 and table 2. The additional columns EWM and Comp. Indicate what kind of event was discovered by identifying it as either an error, warning, or message. The column Comp. identifies in which component of the program coded the event occurred.

Though every possible type of event may occur many times and may be identical in nature to the other events from separate components, each event is uniquely identified by type and time and thus, events are not duplicated anywhere within the system. Each task, process, or component of the embedded system may have its own independent set of trace buffers 214.

After the trace buffers from each individual component of the system are merged (e.g., 313) and the stored events are analyzed (e.g., 326), the errors and possibly warnings are corrected by recoding (328) where necessary. Once the recoding has been conducted, the software code resumes operation, and if errors, warning, and messages are still present, the events return to being analyzed (326) in search of a solution to correct the errors.

The tracing of the program code in each component of the system is preferably always enabled. Should a catastrophic error be discovered, all trace buffers are automatically collected. This collection of all trace buffers may also occur in the event of an authorized user-generated request. Collection of the buffers is preferably directed to non-volatile storage that may be accessed at a later time. After subsequent retrieval from non-volatile storage to an off-board destination, post processing of the buffers occurs. Collection of trace buffers also minimizes the need for re-creation of a catastrophic event should a catastrophic error occur.

By providing the separate buffers 214, the present invention ensures that no component consumes buffer resources needed by other components. Separate buffers 214 for error, warnings, and messages further ensures that more commonly occurring events are prohibited from overwriting more critical events.

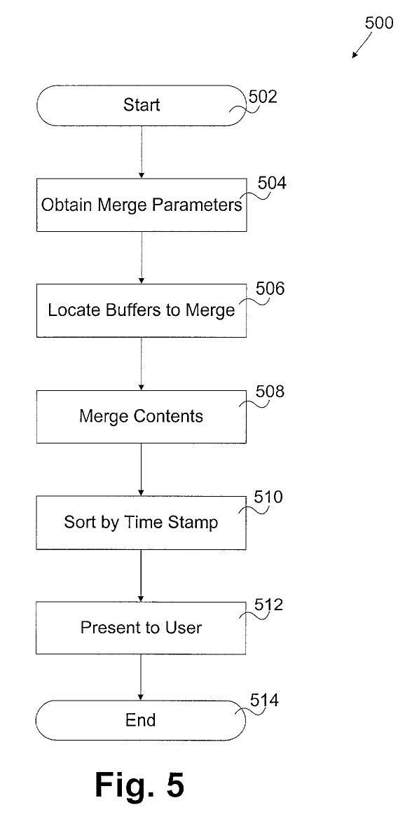

FIG. 5 provides a method 500 of merging events stored in separate buffers 412, 416, and 420 of the present invention. The method 500 starts 502 and the tracing facility obtains 504 the merge parameters. For instance, the merge parameters may indicate how many buffers will be merged and the locations where the merged buffers will be stored. The merge parameters may be set at the time of coding of the program, or may be set by user input. After the merge parameters have been obtained 504, the buffers that are to be merged are located 506. These may include the three separate buffers (e.g., 412, 416, and 420) as described earlier.

The method 500 then merges 508 the contents of these separate buffers into one single buffer. The events stored in separate buffers that are merged together 508 are preferably organized 510 according to the time stamp each has previously received. This allows the user to evaluate each event in the order the event occurred. The contents of the merged buffer are then provided 512 to the user, typically by screen dump or printing. The user is able to then examine the content of the merged events and prioritize the importance of each event found by the tracing facility of the present invention.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus for tracking errors in an embedded system, the apparatus comprising:
a plurality of buffers; and
a tracing module communicating with the plurality of buffers, the tracing module configured to make a record of events occurring during operation of a segment of program code which are useful for finding and correcting errors, the tracing module also configured to selectively transmit the record of events to the plurality of buffers.

2. The apparatus of claim 1, wherein each buffer in the plurality of buffers is configured to store records of a different type of event.

3. The apparatus of claim 2, wherein the different types of events comprise errors, warnings, and messages.

4. The apparatus of claim 1, wherein the plurality of buffers are each assigned to a different functional component of the program code.

5. The apparatus of claim 1, further comprising a merging module configured to combine the records of events stored in the plurality of buffers into a common list of events.

6. The apparatus of claim 5, wherein the common list of events is in chronological order.

7. The apparatus of claim 1, wherein the tracing module is configured to time-stamp each record of an event that is stored in the buffers.

8. The apparatus of claim 5, wherein the merging module is configured to selectively combine the records of events.

9. The apparatus of claim 2, wherein each record of an event is stored together with information about the event.

10. The apparatus of claim 9, wherein the information about the event comprises the type of event.

11. An apparatus for locating errors in an embedded system, the apparatus comprising:
a plurality of buffers;
a tracing module communicating with the plurality of buffers, the tracing module configured to make a record of events occurring during operation of a segment of program code which are useful for finding and correcting errors and to selectively transmit the records of events to the plurality of buffers, the tracing module configured to timestamp each record of an event that is stored in a buffer;
each buffer in the plurality of buffers configured to store a different type of event together with information about the event; and
a merging module configured to selectively combine the records of events from the plurality of buffers into a common list of events organized in chronological order.

12. A method of tracking errors in an embedded system, the method comprising:
providing a plurality of buffers configured to store records of events useful in finding and correcting errors;
tracing the events occurring during operation of a segment of program code; and
selectively storing the records of events within the plurality of buffers.

13. The method of claim 12, wherein selectively storing records of events comprises storing the records of events according to types of the events.

14. The method of claim 13, wherein the types of events comprises errors, warnings, and messages.

15. The method of claim 12, wherein providing a plurality of buffers further comprises assigning each buffer to a different functional component of the program code.

16. The method of claim 15, further comprising merging a plurality of the records of events stored in the plurality of buffers into a common record of events.

17. The method of claim 16, wherein merging the list of events comprises organizing the list of events in chronological order.

18. The method of claim 12, further comprising placing a timestamp on each record of an event stored in the plurality of buffers.

19. The method of claim 11, further comprising storing information about each event together with the record of the event.

20. A method of tracking errors in an embedded system, the method comprising:
providing a plurality of buffers configured to store records of events useful in finding and correcting errors;
tracing the events occurring during operation of a segment of program code;
selectively storing the records of events within the plurality of buffers;
merging records of events from the plurality of buffers into a common record of events; and
organizing the list of events in chronological order.

21. A method of tracking errors in an embedded system, the method comprising:
providing a plurality of buffers configured to store records of events useful in finding and correcting errors;
tracing the events occurring during operation of a segment of program code;
selectively storing the records of events within the plurality of buffers; and
storing the records of events in separate buffers according to types of the events, the types of events comprising errors, warnings, and messages.

22. A computer system having embedded capability for locating errors in a segment of program code, the system comprising:
a computer having a processor;
a plurality of buffers operating within the processor;
a tracing module operating within the processor, communicating with the plurality of buffers, and configured to make a record of events occurring during operation of a segment of program code which are useful for finding and correcting errors and to selectively transmit the record of events to the plurality of buffers, the tracing module configured to timestamp each recorded event that is stored in a buffer.

23. The computer system of claim 22, wherein each buffer in the plurality of buffers configured to store records of a different type of event together with information about the event, and further comprising a merging module configured to selectively combine the records of events from the plurality of buffers into a common record of events organized in chronological order.

24. The computer system of claim 22, wherein separate buffers in the plurality of buffers is configured to store records of a different type of event, the different types of events comprising errors, warnings, and messages.

25. The computer system of claim 24, wherein separate buffers in the plurality of buffers are each assigned to a different functional component of the program code.

26. An embedded system capable of tracking errors in a segment of program code, the embedded system comprising:
a plurality of storage locations configured to store records of events useful in finding and correcting errors;
means for tracing the events occurring during operation of a segment of program code;
means for selectively storing records of the events within the plurality of storage locations; and
means for storing the records of events in separate storage locations according to types of the events, the types of events comprising errors, warnings, and messages.
